(19) United States
(12) Patent Application Publication
(10) Pub. No.: US 2014/0058656 A1
(43) Pub. Date: Feb. 27, 2014

(54) METHOD FOR CALCULATING A PARKING PATH

(71) Applicant: Stephen CHEN, Changhua (TW)

(72) Inventor: Stephen CHEN, Changhua (TW)

(21) Appl. No.: 13/594,878

(22) Filed: Aug. 27, 2012

(51) Int. Cl. G01C 21/00

(52) U.S. Cl. 701/400

(57) ABSTRACT

A method for calculating a parking path, which is capable of simplifying the parking operation and making it easier for the driver to park a vehicle. Since the operation that the driver is required to do simply includes: turning the steering wheel to the extreme left, right and to the center, and driving the vehicle forward and backward, the parking operation is very simple, so that the possibility of error operation can be reduced to the least. In other words, the vehicle can be accurately parked in the parking space as long as the start position is accurate. The automatic parking system just provides reference to the driver, the driver still can made adjustment according to actual conditions.

### BACKGROUND OF THE INVENTION

1. Field of the Invention

The present invention relates to an automatic parking system, and more particularly to a method for calculating a parking path for a vehicle.

2. Description of the Prior Art

A conventional automatic parking system is generally used to assist a driver to park a vehicle by planning a feasible parking path, detecting the parking angle, and comparing to the parking path. The parking path starts by making the driver seat of the host vehicle aligned with the end of the adjacent vehicle, then the parking involves three operations: moving the host vehicle forward, moving back in a direction (to the left or right, for example), and moving back in an opposite direction (to the right or left).

Namely, the parking generally includes three steps: moving forward, moving back to the left (or to the right), moving back to the right (or to the left), and the parking operation is accompanied by the prompt signals generated by the vehicle audio or vehicle horn.

The abovementioned automatic parking system is kind of complicated despite it is able to guide the vehicle to the parking space.

The present invention has arisen to mitigate and/or obviate the afore-described disadvantages.

### SUMMARY OF THE INVENTION

The primary object of the present invention is to provide a method for calculating a parking path, which is capable of simplifying the parking operation and making it easier for the driver to park a vehicle.

To achieve the above object, a method for calculating a parking path comprises the following steps:

step 1, calculating a radius of a turning path of a front outer wheel of a host vehicle based on the minimum turning radius of the host vehicle, and the turning path is a path that the front outer wheel travels when a steering wheel of the host vehicle is turned to the extreme;

step 2, calculating radiuses of turning paths of a rear outer wheel, a rear inner wheel, and a front inner wheel of the host vehicle, based on the radius of the turning path of the front outer wheel, and a wheelbase between front and rear axles of the host vehicle, and a width of the vehicle;

step 3, calculating a radius of a turning path of a front outer corner of the host vehicle based on the radius of the rear outer wheel of the vehicle, the wheelbase, and a distance front an axis of the front wheels to a front edge of the host vehicle;

step 4, defining a distance that the host vehicle needs to travel to a parking space as a horizontal distance, calculating a turning angle of the host vehicle at a turning point of the parking path based on the horizontal distance and the radiuses of the turning paths of the rear inner and outer wheels;

step 5, calculating a perpendicular distance that the vehicle needs to travel perpendicularly to the parking space based on the horizontal distance and the radiuses of the turning paths of the rear inner and outer wheels;

step 6, calculating a start point of the parking path based on a distance front the axis of the rear wheels to the rear edge of the host vehicle, a sum of the width of the host vehicle and a safety allowance, the radius of the turning path of the front outer corner of the host vehicle, and the radius of the turning path of the rear outer wheel of the host vehicle; and

step 7, calculating the parking path based on the start point of the parking path and the turning angle of the host vehicle.

In accordance with another embodiment of the present invention, a method used in combination with a CPU to calculate a parking path, calculation program and data are stored in a parking-path planning software, the method comprises the following steps:

step a, defining specification of a host vehicle, including defining the distance between front and rear axles of the host vehicle as a wheelbase;

step b, defining driving condition of the host vehicle, supposing that all the wheels circle around a same rotating center in a concentric manner, a direction towards the rotating center being defined as an inner direction, and a direction opposite to the inner direction being defined as an outer direction, a radius of a turning path of the front outer wheel of the host vehicle is defined as Rout, a radius of a turning path of the front inner wheel of the host vehicle is defined as Rin, a radius of a turning path of a rear outer wheel of the host vehicle is defined as rout, and a radius of a turning path of a rear inner wheel of the host vehicle is defined as rin;

step c: defining environmental conditions that allow the host vehicle to be parked at a rear end of an adjacent vehicle, defining a side-to-side distance between the host vehicle and the adjacent vehicle as E, defining a parking width, which is the sum of a width of the host vehicle and a safety allowance, as F, a direction from the host vehicle to the adjacent vehicle is defined as a horizontal direction D1, and a direction perpendicular to the horizontal direction D1 is defined as a perpendicular direction D2;

step d, defining that the parking path includes a first path and a second path, the first path is a path that the rear inner wheel of the host vehicle travels when the steering wheel is turned to the extreme in one direction, and the second path is a path that the rear outer wheel of the host vehicle travels when the steering wheel is turned to the extreme in another direction, the first and second paths are connected at a turning point, a start point the parking path d is located at the beginning of first path and an axis of the rear inner wheel of the host vehicle, an end point of the parking path is located at the end of the second path, there are a horizontal distance X and a perpendicular distance Y between the start point and the end point and in the horizontal and perpendicular directions, respectively, the horizontal distance X is a distance that the host vehicle needs to travel horizontally to a parking space, and the perpendicular distance Y is a distance that the host vehicle needs to travel perpendicularly to the parking space, a turning angle θ of the host vehicle at the turning point is calculated based on the radius rout of the turning path of the rear outer wheel and the radius rin of the turning path of the rear inner wheel of the host vehicle.

### BRIEF DESCRIPTION OF THE DRAWINGS

FIG. 1 is a flow chart showing the respective parts of an automatic parking system in accordance with the present invention;

FIG. 2 is an illustrative view showing the method of defining the specification and parking path in accordance with the present invention;

FIG. 3 is an illustrative view showing the method of defining an optimum parking path in accordance with the present invention; and

FIG. 4 is an illustrative view showing the method of defining a safety allowance in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

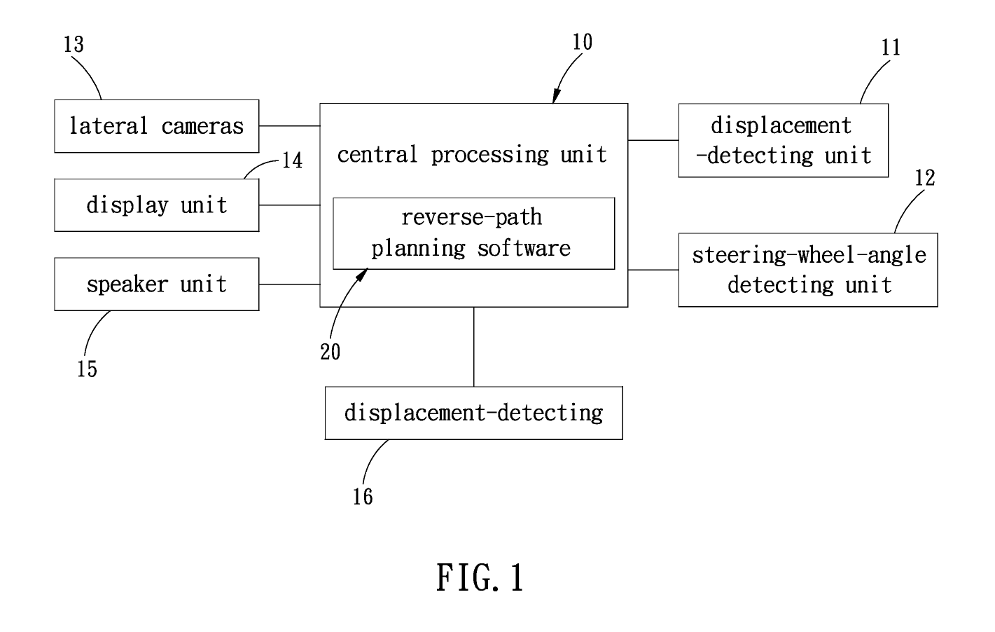

Referring to FIGS. 1-4, an automatic parking system in accordance with the present invention is used to calculate an optimum parking path d and comprises: a CPU (central processing unit) 10, a parking-path planning software 20, two lateral cameras 13, a display unit 14, a displacement-detecting unit 11, a steering-wheel-angle detecting unit 12, and a speaker unit 15.

The parking-path planning software 20 is stored in the CPU 10.

The lateral cameras 13 are connected to the CPU 10 and disposed at the rear left and rear right of a vehicle to monitor the rear of the vehicle.

The display unit 14 is connected to the CPU 10 to display the optimum parking path d, the position of the vehicle, the images taken by the lateral cameras 13, and guiding instructions. The guiding instructions can be shown in the form of characters or pictures, and the guiding instructions can also be combination of images and characters processed by the CPU 10.

The displacement-detecting unit 11 is connected to the CPU 10 to receive the speed signal of the vehicle and then calculate the displacement of the vehicle based on time change, which is expressed by the equation: D=V*T, wherein D represents displacement, V is the speed of the vehicle, T is the time that the vehicle traveled.

Or, the displacement-detecting unit 11 can use gyroscope to calculate the displacement based on the turning angle of the vehicle, which is expressed by the equation: D=turning angle θ*radius.

The steering-wheel-angle detecting unit 12 is connected to the CPU 10 to detect the rotation angle of the steer wheel by receiving the rotation angle signal from the steer wheel or based on the rotation angle of the vehicle detected by the gyroscope and the speed of the vehicle. If no speed of the vehicle is detected, an acceleration sensor can also be used in combination with the gyroscope to detect the rotation angle of the steering wheel. The steering-wheel-angle detecting unit 12 also serves to detect whether the driver turns the steering wheel to the center, or to the extreme left or right. When the steering-wheel-angle detecting unit 12 detects that the driver fails to turn the steering wheel or drive the vehicle to the direction as guided by the automatic parking system, the parking instruction is cancelled immediately.

The speaker unit 15 is connected to the CPU 10 to receive the sound signal from the CPU 10 and play a sound of parking instruction to instruct the driver on how to park the vehicle.

The CPU 10 is connected to the lateral cameras 13, the display unit 14, the displacement-detecting unit 11, the steering-wheel-angle detecting unit 12 and the speaker unit 15 to receive information from these units and do calculation and graphic processing. Based on the minimum turning radius and the size (specification) of the vehicle, especially the wheelbase, the distance from the front wheels to the front edge of the vehicle, and the distance from the rear wheels to the rear edge of the vehicle, the parking-path planning software 20 can calculate the parking path for the driver to follow by fully turning the steering wheel to the extreme left or right. The displacement-detecting unit 11 and the steering-wheel-angle detecting unit 12 can be used to calculate the parking path, and then the parking path is processed by the CPU 10 and displayed on the display unit 14. At the turning point of the park path, sound and picture can be used to prompt the driver to turn the steering wheel. After several times of practice, the driver will be familiar with the meaning of the prompt sound, so he/she doesn't have to watch the display unit 14 when parking the vehicle.

The speaker unit 15 is a buzzer or vehicle audio to receive the sound signal from the CPU 10 and play a sound of parking instruction to instruct the driver on how to park the vehicle.

The display unit 14 is used to display the parking path, the position of the vehicle, the images taken by the lateral cameras 13 and the guiding instructions, and the guiding instructions can also be combination of images and characters processed by the CPU 10.

The automatic parking system further comprises a distance-detecting unit 16 connected to the CPU 10 to detect the distance from the vehicle to objects in front, behind and to the sides of the vehicle. When the distance is too close, the distance-detecting unit 16 will send out warning signals to remind the drivers.

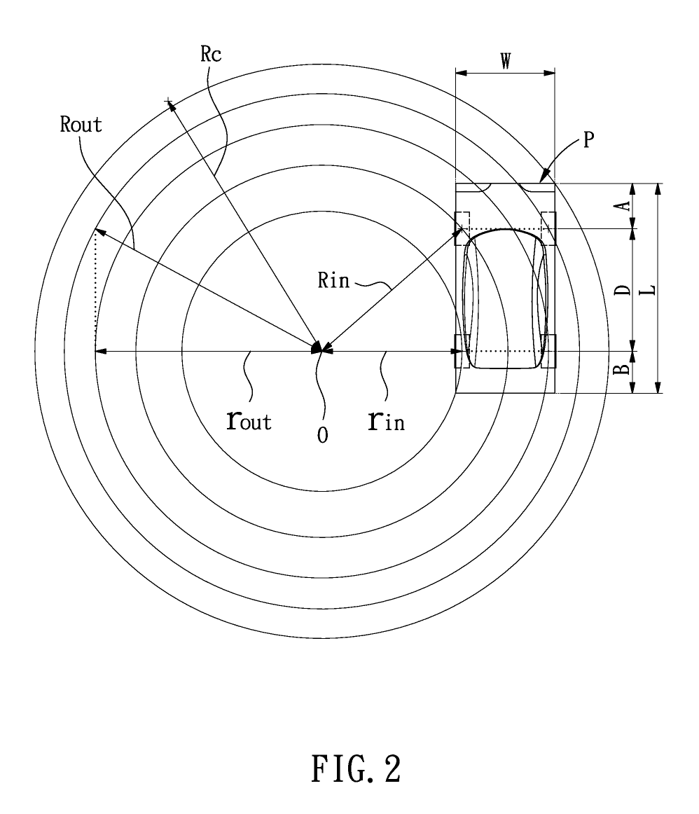

Referring to FIG. 2, which shows a turning path of the host vehicle P, no matter the steering wheel is turned to the extreme right or left, the turning path of the vehicle is the same, hence, based on this characteristic, the present invention designs an optimum parking path d.

FIG. 2 shows the radiuses of the turning paths of the respective wheels and the front outer corner of the vehicle, and the specification of the vehicle is defined as follows:

W: represents the width of the vehicle P.

A: the distance front the axis of the front wheels to the front edge of the vehicle P.

B: the distance front the axis of the rear wheels to the rear edge of the vehicle P.

D: the wheelbase between the front and rear axles of the vehicle P.

L: the length of the vehicle P.

The radiuses of the turning paths of the respective wheels and the front outer corner of the vehicle are calculated based on the specification of the vehicle P, and the radiuses are defined as follows:

Rout: the radius of the turning path of the front outer wheel of the vehicle P;

Rin: the radius of the turning path of the front inner wheel of the vehicle P;

rout: the radius of the turning path of the rear outer wheel of the vehicle P;

rin: the radius of the turning path of the rear inner wheel of the vehicle P;

Rc: the radius of the turning path of the front outer corner of the vehicle P;

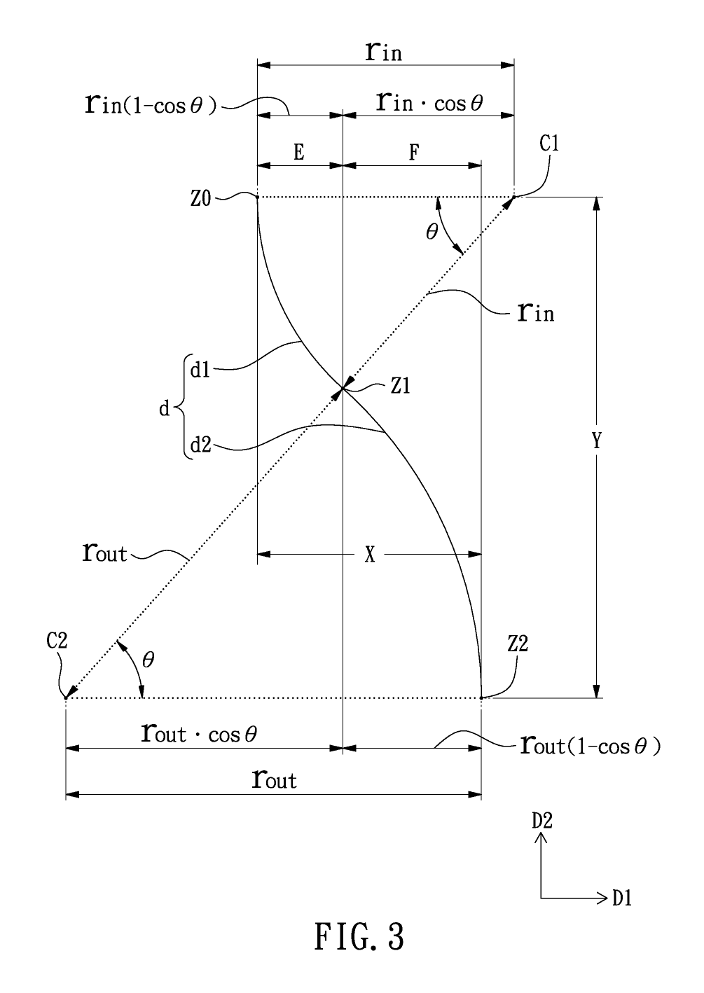

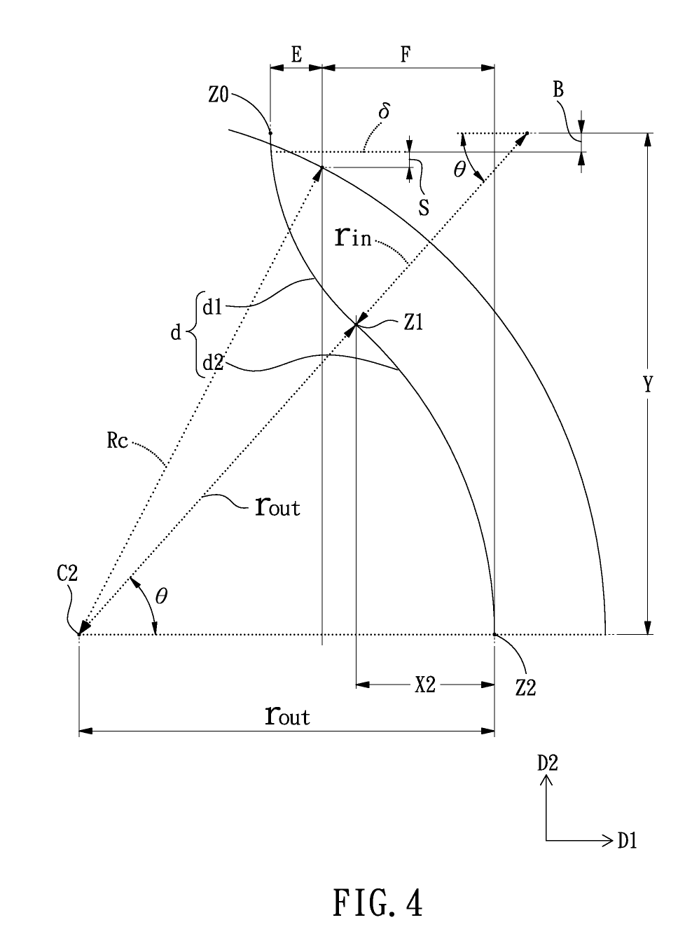

Referring to FIGS. 3 and 4, which show the parking path of the vehicle P, wherein:

E: represents the distance of the vehicle P to an adjacent vehicle.

F: the sum of the width of the vehicle P and a safety allowance.

X: a horizontal distance that the vehicle is required to travel horizontally to the parking space.

Y: a perpendicular distance that the vehicle is required to travel perpendicularly to the parking space.

θ: a turning angle of the vehicle P at the turning point of the parking path.

c1: represents the center of a first turning path, wherein the first path of the rear right wheel is d1, and the radius is rin.

c2: represents the center of a second turning path, wherein the second path of the rear right wheel is d2, and the radius is rout.

Based on the above definition, a method for calculating a parking path used in combination with the automatic parking system comprises the following steps:

Step 1, calculating the radius of the turning path of the front outer wheel of the vehicle P based on the minimum turning radius of the vehicle P, and the turning path of the turning path of the front outer wheel is the path that the front outer wheel travels when the steering wheel is turned to the extreme. The minimum turning radius of the vehicle P is the turning path of the front outer wheel when the steering wheel is turned to the extreme, therefore, Rout=the minimum turning radius of the vehicle P.

Step 2: calculating the radiuses of the turning paths of the rear outer wheel, the rear inner wheel, and the front inner wheel of the vehicle P, based on the radius of the turning path of the front outer wheel, and the wheelbase of the vehicle P.

It is apparent from the FIGS. 2, 3 and 4 that Rin is hypotenuse, rin is an adjacent side, and D is an opposite side, according to the trigonometric function, Rin=\sqrt{rin²+D²}.

rout is an adjacent side, Rout is hypotenuse, and D is an opposite side, according to the trigonometric function, rout=\sqrt{Rout²−D²}.

rin=rout−W, however, the wheels have width, the axles of the wheels will be recessed and the body of the vehicle will be projected outward, hence, it requires correction, and the correction amount is C (not shown). Therefore, rin=rout−W+C.

step 3: calculating a radius of the turning paths of the front outer corner of the vehicle P based on the radius rout of the rear outer wheel of the vehicle, the wheelbase, and the distance A front the axis of the front wheels to the front edge of the vehicle P.

It is apparent from FIGS. 3 and 4 that Rin is hypotenuse, and D+A is an opposite side, according to the trigonometric function, Rc=\sqrt{rout²+(D+A)²}.

Step 4: a distance that the vehicle is required to travel to the parking space is defined as a horizontal distance, calculating the turning angle θ of the vehicle P at the turning point of the parking path based on the horizontal distance and the radiuses of the turning paths of the rear inner and outer wheels.

It is apparent from FIGS. 3 and 4 that the horizontal distance equals the sum of the width of the vehicle P and a safety allowance (10-15 cm) and the distance from the vehicle P to an adjacent vehicle, that is:

$$X = E + F = rin ( 1 - cos θ ) + rout ( 1 - cos θ ) = ( rout + rin ) ( 1 - cos θ ) . \\ X 1 = rin ( 1 - cos θ ) ;$$

$$X 2 = rout ( 1 - cos θ ) ;$$

$$X = X 1 + X 2 = rin ( 1 - cos θ ) + rout ( 1 - cos θ ) = ( rout + rin ) ( 1 - cos θ ) ;$$

$$X = ( rout + rin ) ( 1 - cos θ ) ;$$

$$1 - cos θ = \frac{X}{rout + rin} ;$$

$$cos θ = 1 - \frac{X}{rout + rin} ;$$

$$θ = {cos}^{- 1} ( 1 - \frac{X}{rout + rin} ) ;$$

The turning angle θ varies with the change of the horizontal distance X, when the horizontal distance X is fixed, the turning angle θ can be calculated based on the above equations, and consequently, the parking path d, the turning point and end point of the parking path can also be calculated and fixed.

Step 5: calculating a perpendicular distance Y that the vehicle is required to travel perpendicularly to the parking space based on the horizontal distance and the radiuses of the turning paths of the rear inner and outer wheels.

It is apparent from FIGS. 3 and 4 that (rin+rout) is hypotenuse, and Y is an opposite side, according to the trigonometric function, Y=(rin+rout)sin θ.

Step 6: calculating the start point of the parking path based on the distance B front the axis of the rear wheels to the rear edge of the vehicle P, the sum F of the width of the vehicle P and a safety allowance (10-15 cm), the radius Rc of the turning path of the front outer corner of the vehicle P, and the radius rout of the turning path of the rear outer wheel of the vehicle P the radius of the turning path of the rear outer wheel of the vehicle P.

As shown in FIGS. 3 and 4, S is defined as a distance from a point of intersection between the radius Rc of the turning path of the front outer corner of the vehicle P and the body of the vehicle P to the rear edge of an adjacent vehicle. (rout−F) is an adjacent side, Rc is a hypotenuse, (Y−B−S) is an opposite side, according to the trigonometric function,

Rc²=(Y−B−S)²+(rout−F)²;

(Y−B−S)=\sqrt{Rc²−(rout−F)²};

S=Y−\sqrt{Rc²−(rout−F)²−B};

S is also the distance the host vehicle P travels forward, according to the calculated parking path, the head of the host vehicle P will just scratch the rear edge of the adjacent vehicle when rotating. To prevent scratch, the calculated S should be deducted by 5-10 cm.

Step 7: calculating the parking path based on the calculated start point of the parking path and the turning angle θ of the vehicle P.

As shown in FIGS. 3 and 4, the optimum parking path d is the path that the vehicle travels when the steering wheel is turned to the extreme right or left. The start point of the parking path calculated in step 6 and the turning angle θ of the vehicle P at the turning point in step 4 are defined as the parking path. B is the distance from the axis of the rear wheels to the rear edge of the vehicle P. E represents the distance of the vehicle P to an adjacent vehicle. F is the sum of the width of the vehicle P and a safety allowance. X is a horizontal distance that the vehicle P is required to travel horizontally to the parking space. Y is a perpendicular distance that the vehicle P is required to travel perpendicularly to the parking space. The d1 is a first path of the rear right wheel of the vehicle P. The d2 is a second path of the rear right wheel of the vehicle P. δ is a start line of the parking path, Z0, Z1 and Z2 represent the start point, turning point and end point of the parking path, respectively. C1 and C2 represent the centers of first and second turning paths.

When parking, the driver firstly stops the host vehicle P beside an adjacent vehicle, then turns on the automatic parking system, the display unit 14 will display the images taken by the lateral cameras 13, the distance-detecting unit 16 detects the distance to the adjacent vehicle, so that the horizontal distance that the vehicle P is required to travel horizontally to the parking space can be calculated by adding the width of the vehicle P, a safety allowance (10-15 cm) and the distance to the adjacent vehicle together. Moreover, the turning angle θ of the vehicle P at the turning point of the parking path, the start line 6 of the parking path, a parking path (the first path d1+the second path d2), the start point, turning point and end point of the parking path, respectively. C1 and C2 represent the centers of first and second turning paths.

The start line δ of the parking path and the images taken by the lateral cameras 13 are displayed on the display unit 14 to guide the driver to move the vehicle P to the start point Z0 of the parking path d. The driver stops the vehicle P once the images taken by the lateral cameras 13 displayed on the display unit 14 show that the vehicle P is moved to a position where the start line δ of the parking path is flush with the rear edge of the adjacent vehicle. The guiding instruction for guiding the driver to park the car can be expressed in characters, sound, voice or patterns.

After the vehicle P stops at the start point Z0 of the parking path d, the automatic parking system instructs the driver to turn the steering wheel to the extreme right (in clockwise direction) and drive the vehicle P backward, so that the front right wheel starts rolling reversely from the start point Z0 along the first path d1. The displacement-detecting unit 11 will detect the actual parking path of the vehicle P. If the driver drives the vehicles P exactly as the guiding instruction of the automatic parking system, the displacement-detecting unit 11 will calculate the displacement of the vehicle P by the equation: D=V*T, wherein D represents displacement, V is the speed of the vehicle, T is the time that the vehicle traveled. When the D equals the length of the first path d1, it means that the vehicle P moves to the turning point Z1, and then the automatic parking system will send out another instruction to the driver. Or, the displacement-detecting unit 11 can use gyroscope to calculate the displacement based on the rotation angle of the vehicle P, which is expressed by the equation: D=turning angle θ*radius. When the D equals the length of the first path d1, or the detected turning angle of the vehicle is equal to the turning angle θ, it means that the vehicle P moves to the turning point Z1, and then the automatic parking system will send out another instruction to the driver. The guiding instruction for guiding the driver to park the car can be expressed in characters, sound, voice or patterns.

When the vehicle P moves to the turning point Z1, the display unit 14 will instructs the driver to turn the steering wheel to the extreme left (in the counterclockwise direction) and drive the vehicle P backward, so that the front right wheel starts rolling reversely from the turning point Z1 along the second path d2. The displacement-detecting unit 11 will detect the actual parking path of the vehicle P. If the driver drives the vehicles P exactly as the guiding instruction of the automatic parking system, the displacement-detecting unit 11 can calculate the displacement of the vehicle P by the equation: D=V*T, wherein D represents displacement, V is the speed of the vehicle, T is the time that the vehicle travelled. When the D equals the length of the second path d2, it means that the vehicle P moves to the end point Z2, and then the automatic parking system will send out another instruction to the driver.

Or, the displacement-detecting unit 11 can use gyroscope to calculate the displacement based on the rotation angle of the vehicle, which is expressed by the equation: D=turning angle θ*radius. When the D equals the length of the second path d1, or the detected turning angle of the vehicle is equal to the turning angle θ, it means that the vehicle P moves to the end point Z2, and then the automatic parking system will send out another instruction to the driver. The guiding instruction for guiding the driver to park the car can be expressed in characters, sound, voice or patterns.

When the vehicle P moves to the end point Z2, the display unit 14 will instructs the driver to turn the steering wheel to the center and stop the vehicle P at the predetermined parking space, and the parking is done. The guiding instruction for guiding the driver to park the car can be expressed in characters, sound, voice or patterns.

Since the operation that the driver is required to do simply includes turning the steering wheel to the extreme left, right and to the center, and driving the vehicle forward and backward, the parking operation is very simple, so that the possibility of error operation can be reduced to the least. In other words, the vehicle P can be accurately parked in the parking space as long as the start position is accurate. The automatic parking system just provides reference to the driver, the driver still can made adjustment according to actual conditions.

Based on the minimum turning radius and the size of the vehicle, especially the wheelbase, the distance from the front wheels to the front edge of the vehicle, and the distance from the rear wheels to the rear edge of the vehicle, the parking-path planning software 20 can calculate the parking path for the driver to follow by fully turning the steering wheel to the extreme left or right.

It is apparent from the above description that the parking-path planning software 20 can cooperate with other calculating, detecting and warning devices (including the lateral cameras 13, display unit 14, displacement-detecting unit 11, steering-wheel-angle detecting unit 12, and the speaker unit 15) to instruct the driver to turn the steering wheel to extreme in one direction and then in another direction, and turn the steering wheel to the center, and then drive the vehicle P forward or backward. Hence, the parking operation can be very simple.

A method of another embodiment of the present invention for calculating a parking path is used in combination with a CPU 10 to calculate an optimum parking path d. The calculation program and related data are stored in a parking-path planning software 20. The CPU 10 is electrically to two lateral cameras 13, a display unit 14, a displacement-detecting unit 11, a steering-wheel-angle detecting unit 12, a speaker unit 15, and distance-detecting units 16.

The displacement-detecting unit 11 serves to calculate the displacement of the vehicle P. The steering-wheel-angle detecting unit 12 serves to detect the turning angle of the vehicle P. The lateral cameras 13 serve to monitor lateral sides of the vehicle. The display unit 14 serves to display the images taken by the lateral cameras 13, related information or warning patterns. The speaker unit 15 is controlled by the CPU 10 to play warning (prompt) sound. The distance-detecting units 16 are disposed at both lateral sides of the vehicle to detect the distance from the vehicle to objects to the sides of the vehicle P.

The method of another embodiment of the present invention for calculating an optimum parking path d comprises the following steps:

Step a: defining the specification of a vehicle P: including defining the width of the vehicle P as W, defining the distance from the axis of the front wheels to the front edge of the vehicle P as A, defining the distance from the axis of the rear wheels to the rear edge of the vehicle P as B, defining the sum of the width of the wheels of the vehicle P and the thickness of the body of the vehicle P that protrudes out of the wheels as C, defining the wheelbase between the front and rear axles of the vehicle P as D, and defining the length of the vehicle P as L.

Step b: defining the driving condition of the vehicle P: during the parking process, making the vehicle P turn in such manner that the steering wheel is turned to the extreme (left or right), in other words, the vehicle P turns at the minimum turning radius, and all the wheels circle around the same rotating center in a concentric manner. The minimum turning radius is known, a direction towards the rotating center is defined as an inner direction, and a direction opposite to the inner direction is defined as an outer direction. The radius of the turning path of the front outer wheel of the vehicle P is defined as Rout. The radius of the turning path of the front inner wheel of the vehicle P is defined as Rin. The radius of the turning path of the rear outer wheel of the vehicle P is defined as rout. The radius of the turning path of the rear inner wheel of the vehicle P is defined as rin, and the radius of the turning path of the front outer corner of the vehicle P is defined as Rc. The radius Rout of the turning path of the front outer wheel of the vehicle P is the minimum turning radius of the vehicle P.

Then, based on trigonometric function and Pythagorean Theorem, and the travel paths as shown in FIG. 2, the specification of the vehicle P and the radius Rout of the turning path of the front outer wheel, it can define the following parameters:

Rin=\sqrt{rin²+D²}, wherein Rin is hypotenuse, rin is an opposite side, and D is an adjacent side.

rout=\sqrt{Rout²−D²}, wherein rout is an opposite side, Rout is hypotenuse, and D is an adjacent side.

rin=rout−W;

Rin is hypotenuse, and D+A is an adjacent side, rout is an opposite side, Rc=\sqrt{rout²+(D+A)²}.

Step c: defining the environmental conditions: including defining the environmental conditions that allow the vehicle P to be parked at the rear end of an adjacent vehicle, wherein the side-to-side distance between the vehicle P and an adjacent vehicle is defined as E, and a parking width of the vehicle P, which is the sum of the width of the vehicle P and a safety allowance, is defined as F, a direction from the vehicle P to the adjacent vehicle is defined as a horizontal direction D1, and a direction perpendicular to the horizontal direction D1 is defined as a perpendicular direction D2.

Step d: defining an optimum parking path: defining that the optimum parking path d includes a first path d1 and a second path d2, a start point Z0 of the optimum parking path d is located at the beginning of first path d1 and represents the axis of the rear inner wheel of the vehicle P. The end point Z2 of the optimum parking path d is located at the end of the second path d2. There are a horizontal distance X and a perpendicular distance Y between the start point Z0 and the end point Z2 and in the horizontal and perpendicular directions D1, D2, respectively. The horizontal distance X is a distance that the vehicle is required to travel horizontally to the parking space, and the perpendicular distance Y is a distance that the vehicle is required to travel perpendicularly to the parking space. When the rear inner wheel of the vehicle P is located at the start point Z0, the side-to-side distance between the vehicle P and the adjacent vehicle is E.

Then, the first path d1 is defined as the path that the rear inner wheel of the vehicle P travels when the steering wheel is turned to the extreme in one direction (to the extreme left, for example), and the second path d2 is a path that the rear outer wheel of the vehicle P travels when the steering wheel is turned to the extreme in another direction (to the extreme right). The first and second paths d1, d2 are connected at the turning point Z1, so that, the turning angle θ of the vehicle P at the turning point Z1 can be calculated based on the radius rout of the turning path of the rear outer wheel of the vehicle P and the radius rin of the turning path of the rear inner wheel of the vehicle P, which are known and fixed, and the side-to-side detected distance E between the vehicle P and the adjacent vehicle.

Then, a center of the first path d1 is defined as a first rotating center C1, and a center of the second path d2 is defined as a second rotating center C2.

After that, the turning angle θ of the vehicle P can be defined by the first and second paths d1, d2.

The horizontal distance X that the vehicle P needs to travel to the parking space is the sum of the side-to-side distance E between the vehicle P and a adjacent vehicle and the parking width F, namely, the sum of X1 and X2. Based on the data of the first path d1 and the turning angle θ of the vehicle P, and suppose that the radius rin of the rear inner wheel is hypotenuse, the adjacent side is rin·cos θ, the angle between the hypotenuse and the adjacent side is the turning angle θ, and the sum of the length of the adjacent side and X1 is rin, the X1 can be calculated as: X1=rin(1−cos θ).

Then, based on the data of the first path d1 and the turning angle θ of the vehicle P, and suppose that the radius rout of the rear outer wheel is hypotenuse, the adjacent side is rout·cos θ, the angle between the hypotenuse and the adjacent side is the turning angle θ, and the sum of the length of the adjacent side and the X2 is rout, then X2 can be calculated as: X2=rout (1−cos θ).

Once the side-to-side distance E between the vehicle P and the adjacent vehicle, and the parking width F are fixed, the horizontal distance X that the vehicle P needs to travels to the parking space can be calculated as:

X=E+F=X1+×2=rin(1−cos θ)+rout(1−cos θ)=(rout+rin)(1−cos θ);

And X=(rout+rin)(1−cos θ);

Based on the above equations, the turning angle θ can be calculated as:

$$1 - cos θ = \frac{X}{rout + rin} ;$$

$$Then , cos θ = 1 - \frac{X}{rout + rin} ;$$

$$And θ = {cos}^{- 1} ( 1 - \frac{X}{rout + rin} ) ;$$

Meanwhile, the perpendicular distance Y that the vehicle P travels to the parking space can also be calculated as: Y=(rin+rout)sin θ, wherein (rin+rout) is hypotenuse, Y is an opposite side, and θ is the angle between the hypotenuse and the adjacent side.

It is understood from the above equation that the turning angle θ varies with the change of the horizontal distance X.

The above equations are stored in the parking-path planning software 20 of the CPU 10. When the specification of the vehicle P and the side-to-side distance E from the vehicle P to the adjacent vehicle are fixed, the turning angle θ and the parking path d can be calculated.

Furthermore, a safety allowance S can be calculated (defined), based on the radius Rc of the turning path of the front outer corner of the vehicle P and the perpendicular distance Y, to prevent the vehicle P from scratching the adjacent vehicle. The vehicle P will turn (circle) around the second rotating center C2 of the second path d, Rc²=(Y−B−S)²+(rout−F)²

(Y−B−S)=\sqrt{Rc²−(rout−F)²}

S=Y−\sqrt{Rc²−(rout−F)²}−B

When the vehicle P is parked in the parking space as guided, the safety allowance S is the distance from the vehicle P to the adjacent vehicle. In other words, if the vehicle P, after parking, further moves the safety allowance S forward, it will scratch the adjacent vehicle. The safety allowance S is stored in the parking-path planning software 20.

The parking-path planning software 20 cooperates with the CPU 10 to calculate the parking path to guide the driver to park the vehicle, and the displacement-detecting unit 11 will detect whether the actual parking path that the vehicle P travels is exact the same as the calculated optimum parking path d.

During the parking process, the distance-detecting unit 16 detects the side-to-side distance E from the vehicle P to the adjacent vehicle, or the lateral cameras 13 can also be used to detect the side-to-side distance E. The minimum turning radius and the specification of the vehicle P are stored in the parking-path planning software 20, so that the parking-path planning software 20 can calculate the radius Rin of the turning path of the front inner wheel of the vehicle P, the radius rin of the turning path of the rear inner wheel of the vehicle P, the radius rout of the turning path of the rear outer wheel of the vehicle P, and the radius Rc of the turning path of the front outer corner of the vehicle P. And then the parking-path planning software 20 the parking-path planning software 20 is able to calculate the turning angle θ of the vehicle P and the perpendicular distance Y as well, and thus the entire parking path d can be calculated. Then, the CPU 10 can guide the driver to park the vehicle P based on the calculated optimum parking path d. When the vehicle P stops at the start point Z0 of the optimum parking path d, the CPU 10 instructs the speaker unit 15 to produce warning signals to remind the driver to turn the steering wheel toward the parking space, and the steering wheel is turned to the extreme. Meanwhile, the displacement-detecting unit 11 and the steering-wheel-angle detecting unit 12 serve to detect the displacement and turning angle of the vehicle P. When the displacement-detecting unit 11 detects that the displacement of the vehicle P is equal to the length of the first path d1, and the detected turning angle of the vehicle is equal to the turning angle θ, the speaker unit 15 sends out warning signals again to order the driver to reversely turn the steering wheel to the extreme. In other words, the vehicle P starts to travel along the second path d2, when the displacement-detecting unit 11 and the steering-wheel-angle detecting unit 12 detect that the displacement of the vehicle P is equal to the length of the second path d2, and the detected turning angle of the vehicle is equal to the turning angle θ, the speaker unit 15 sends out warning signals again to remind the driver that the vehicle P has been parked in the parking space, and the driver just needs to turn the steering wheel back to the center. During the backward and forward line displacement of the vehicle P, the displacement-detecting unit 11 also detects whether the amount of displacement of the vehicle P is within the safety allowance S, ensuring that the vehicle P is maintained at a safety distance from the adjacent vehicle.

While we have shown and described various embodiments in accordance with the present invention, it is clear to those skilled in the art that further embodiments may be made without departing from the scope of the present invention.

What is claimed is:

1. A method for calculating a parking path comprising the following steps:
step 1, calculating a radius of a turning path of a front outer wheel of a host vehicle based on the minimum turning radius of the host vehicle, and the turning path being a path that the front outer wheel travels when a steering wheel of the host vehicle is turned to the extreme;
step 2, calculating radiuses of turning paths of a rear outer wheel, a rear inner wheel, and a front inner wheel of the host vehicle, based on the radius of the turning path of the front outer wheel, and a wheelbase between front and rear axles of the host vehicle, and a width of the vehicle;
step 3, calculating a radius of a turning path of a front outer corner of the host vehicle based on the radius of the rear outer wheel of the vehicle, the wheelbase, and a distance from an axis of the front wheels to a front edge of the host vehicle;
step 4, defining a distance that the host vehicle needs to travel to a parking space as a horizontal distance, calculating a turning angle of the host vehicle at a turning point of the parking path based on the horizontal distance and the radiuses of the turning paths of the rear inner and outer wheels;
step 5, calculating a perpendicular distance that the vehicle needs to travel perpendicularly to the parking space based on the horizontal distance and the radiuses of the turning paths of the rear inner and outer wheels;
step 6, calculating a start point of the parking path based on a distance from the axis of the rear wheels to the rear edge of the host vehicle, a sum of the width of the host vehicle and a safety allowance, the radius of the turning path of the front outer corner of the host vehicle, and the radius of the turning path of the rear outer wheel of the host vehicle; and
step 7, calculating the parking path based on the start point of the parking path and the turning angle of the host vehicle.

2. The method for calculating a parking path as claimed in claim 1, wherein in the step 2, the width of the host vehicle is defined as W, the wheelbase between the front and rear axles of the host vehicle is D, the radius of the turning path of the front outer wheel of the host vehicle is Rout, the radius of the turning path of the front inner wheel of the host vehicle is Rin, the radius of the turning path of the rear outer wheel of the host vehicle is rout, the radius of the turning path of the rear inner wheel of the host vehicle is rin, and rin=rout−W.

3. The method for calculating a parking path as claimed in claim 1, wherein in the step 2, the width of the host vehicle is defined as W, the wheelbase between the front and rear axles of the host vehicle is D, the radius of the turning path of the front inner wheel of the host vehicle is Rin, the radius of the turning path of the rear inner wheel of the host vehicle is rin, and Rin=\sqrt{rin²+D²}.

4. The method for calculating a parking path as claimed in claim 1, wherein in the step 2, a distance front an axis of the front wheels to the front edge of the host vehicle is A, the wheelbase between the front and rear axles of the host vehicle is D, the radius of the turning path of the front outer wheel of the host vehicle is Rout, the radius of the turning path of the rear outer wheel of the host vehicle is rout, and rout=\sqrt{Rout²−D²}.

5. The method for calculating a parking path as claimed in claim 1, wherein in the step 3, the distance front the axis of the front wheels to the front edge of the host vehicle is defined as A, the wheelbase between the front and rear axles of the host vehicle is D, the radius of the turning path of the front outer wheel of the host vehicle is Rout, the radius of the turning path of the front outer corner of the host vehicle is defined as Rc, and Rc=\sqrt{rout′+(D+A)′}.

6. The method for calculating a parking path as claimed in claim 1, wherein in the step 4, the turning angle of the host vehicle is defined as θ, the horizontal distance is X, the radius of the turning path of the rear outer wheel of the host vehicle is rout, the radius of the turning path of the rear inner wheel of the host vehicle is rin, and
$$θ = {cos}^{- 1} ( 1 - \frac{X}{rout + rin} ) .$$

7. The method for calculating a parking path as claimed in claim 1, wherein in the step 5, the turning angle of the host vehicle is defined as θ, the radius of the turning path of the rear outer wheel of the host vehicle is rout, the radius of the turning path of the rear inner wheel of the host vehicle is rin, the perpendicular distance is Y, and Y=(rin+rout)sin θ.

8. The method for calculating a parking path as claimed in claim 1, wherein in the step 6, the distance front the axis of the rear wheels to the rear edge of the host vehicle is B, the sum of the width of the host vehicle and the safety allowance is F, the radius of the turning path of the front outer corner of the host vehicle is Rc, a distance from a point of intersection between the radius Rc and a body of the host vehicle to a rear edge of an adjacent vehicle is defined as S, the radius of the turning path of the rear outer wheel of the host vehicle is rout, the perpendicular distance is Y, and S=Y−\sqrt{Rc²−(rout−F)²}−B.

9. The method for calculating a parking path as claimed in claim 1, wherein in the step 2, the width of the host vehicle is defined as W, the wheelbase between the front and rear axles of the host vehicle is D, the radius of the turning path of the front outer wheel of the host vehicle is Rout, the radius of the turning path of the front inner wheel of the host vehicle is Rin, the radius of the turning path of the rear outer wheel of the host vehicle is rout, the radius of the turning path of the rear inner wheel of the host vehicle is rin, rin=rout−W, the wheels have width, the axles of the wheels will be recessed and the body of the vehicle will be projected outward, hence, it requires correction, and the correction amount is C, therefore, rin=rout−W+C.

10. The method for calculating a parking path as claimed in claim 1, wherein in the step 4, the horizontal distance equals the sum of the width of the host vehicle and the safety allowance and a distance from the host vehicle to an adjacent vehicle.

11. A method used in combination with a CPU to calculate a parking path, calculation program and data are stored in a parking-path planning software, the method comprising the following steps:
step a, defining specification of a host vehicle, including defining the distance between front and rear axles of the host vehicle as a wheelbase;
step b, defining driving condition of the host vehicle, supposing that all the wheels circle around a same rotating center in a concentric manner, a direction towards the rotating center being defined as an inner direction, and a direction opposite to the inner direction being defined as an outer direction, a radius of a turning path of the front outer wheel of the host vehicle being defined as Rout, a radius of a turning path of the front inner wheel of the host vehicle being defined as Rin, a radius of a turning path of a rear outer wheel of the host vehicle being defined as rout, and a radius of a turning path of a rear inner wheel of the host vehicle being defined as rin;
step c, defining environmental conditions that allow the host vehicle to be parked at a rear end of an adjacent vehicle, defining a side-to-side distance between the host vehicle and the adjacent vehicle as E, defining a parking width, which is the sum of a width of the host vehicle and a safety allowance, as F, a direction from the host vehicle to the adjacent vehicle being defined as a horizontal direction D1, and a direction perpendicular to the horizontal direction D1 being defined as a perpendicular direction D2;
step d, defining that the parking path includes a first path and a second path, the first path is a path that the rear inner wheel of the host vehicle travels when the steering wheel is turned to the extreme in one direction, and the second path is a path that the rear outer wheel of the host vehicle travels when the steering wheel is turned to the extreme in another direction, the first and second paths are connected at a turning point, a start point the parking path d is located at the beginning of first path and an axis of the rear inner wheel of the host vehicle, an end point of the parking path is located at the end of the second path, there are a horizontal distance X and a perpendicular distance Y between the start point and the end point and in the horizontal and perpendicular directions, respectively, the horizontal distance X is a distance that the host vehicle needs to travel horizontally to a parking space, and the perpendicular distance Y is a distance that the host vehicle needs to travel perpendicularly to the parking space, a turning angle θ of the host vehicle at the turning point is calculated based on the radius rout of the turning path of the rear outer wheel and the radius rin of the turning path of the rear inner wheel of the host vehicle.

12. The method as claimed in claim 11, wherein the CPU is electrically connected to lateral cameras, a display unit, a displacement-detecting unit, a steering-wheel-angle detecting unit, a speaker unit, and a distance-detecting unit;
the displacement-detecting unit serves to calculate the displacement of the host vehicle, the steering-wheel-angle detecting unit serves to detect the turning angle of the host vehicle, the lateral cameras serve to monitor lateral sides of the host vehicle, the display unit serves to display images taken by the lateral cameras, guiding instructions and warning patterns, the speaker unit is controlled by the CPU to play warning signals, the distance-detecting unit is disposed at both lateral sides of the vehicle to detect the distance from the host vehicle to objects to the sides of the host vehicle, the CPU cooperates with the parking-path planning software to calculate the parking path and the turning angle θ of the host vehicle based on the side-to-side distance E between the host vehicle and the adjacent vehicle.

13. The method as claimed in claim 11, wherein Rin=\sqrt{rin²+D²}, Rin is hypotenuse, rin is an opposite side, and D is the wheelbase and is an adjacent side.

14. The method as claimed in claim 11, wherein rout=\sqrt{Rout²−D²}, rout is an opposite side, Rout is hypotenuse, and D is an adjacent side.

15. The method as claimed in claim 11, wherein rin=rout−W, W is the width of the host vehicle.

16. The method as claimed in claim 11, wherein the radius of the turning path of the front outer corner of the vehicle is defined as Rc, Rin is hypotenuse, and D+A is an adjacent side, rout is an opposite side, and Rc=\sqrt{route²+(D+A)²}.
$$θ = {cos}^{- 1} ( 1 - \frac{X}{rout + rin} ) .$$

17. The method as claimed in claim 11, wherein

18. The method as claimed in claim 11, wherein the perpendicular distance Y that the vehicle travels to the parking space is calculated as: Y=(rin+rout)sin θ.

19. The method as claimed in claim 11, wherein a safety allowance S can be calculated, based on the radius Rc of the turning path of the front outer corner of the vehicle and the perpendicular distance Y, to prevent the vehicle from scratching the adjacent vehicle, the vehicle will turn around the second rotating center C2 of the second path d, S=Y−\sqrt{Rc²−(rout−F)²}
